(19) United States
(12) Patent Application Publication
(10) Pub. No.: US 2026/0258826 A1
(43) Pub. Date: Sep. 3, 2026

(54) Fastener

(71) Applicant: Illinois Tool Works Inc., Glenview, IL (US)

(72) Inventors: Mahantesh S. Gokavi, Pune (IN); Suryabhanu S. Kadam, Pune (IN)

(21) Appl. No.: 19/552,661

(22) Filed: Feb. 27, 2026

(30) Foreign Application Priority Data
Mar. 3, 2025 (IN) 202511018916

(51) Int. Cl. F16B 5/06; F16B 2/22

(52) U.S. Cl. CPC F16B 5/065; F16B 2/22

(57) ABSTRACT

A fastener and a fastener system including a first component and a second component secured together through the fastener. The fastener includes a body portion having a plurality of ribs arranged to form a bend section, and a bridge connecting the ribs to one another at the bend section. A shank portion extends from the body portion and includes a plurality of arms. Each arm is connected to a respective rib at a point of connection located at a free end of the rib. The arms are cantilevered at the point of connection and extending away from the body portion. Each arm being hingeable about the point of connection with the rib. The ribs include a recessed portion formed along at least a portion of the rib between the point of connection and the bend section. The recessed portion being configured to regulate at least an insertion force of the fastener.

### RELATED APPLICATION

The present application claims the benefit of Indian Patent Application No. 202511018916, filed Mar. 3, 2025, titled “Fastener,” the contents of which are hereby incorporated by reference.

### BACKGROUND

Various types of fasteners are used for fastening components. For example, in case of an instrument panel of a vehicle, fasteners may be used to fix together adjacent panels or to secure one or more objects on the panels. One such type of fastener is usable with openings of different types, sizes, and shapes provided in the components to be secured together. In other words, for such a fastener to fasten the components, at least one of the components is provided with an opening. One of the components is mounted on the fastener and other component having the opening receives the fastener-component assembly.

Fasteners used for mounting a component to another component having an opening are widely used. One component is mounted to the fastener, the assembly referred to as a mounted fastener. The opening in the other component receives the mounted fastener, thereby coupling the two components.

### SUMMARY

The present disclosure relates generally to a fastening system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates an isometric assembly view of a fastening system, in accordance with an example implementation of the present disclosure.

FIGS. 2a through 2c illustrate side views of the fastening system in different stages of assembly, in accordance with an example implementation of the present disclosure.

FIGS. 3a and 3b illustrate, respectively, top side and under side isometric views of the fastener, in accordance with an example implementation of the present disclosure.

FIGS. 3c and 3d illustrate front and rear elevation views of the fastener, in accordance with an example implementation of the present disclosure.

FIGS. 3e and 3f illustrate first and second side elevation views of the fastener, in accordance with an example implementation of the present disclosure.

FIGS. 3g and 3h illustrate, respectively, topside and underside plan views of the fastener, in accordance with an example implementation of the present disclosure.

FIGS. 4a and 4b illustrate detailed cross-sectional views of the recessed portion of the rib of the fastener, taken along cut line A-A as shown in FIG. 3e, in accordance with an example implementation of the present disclosure.

FIG. 4c illustrates a detailed cross-sectional view of the recessed portion of the rib of the fastener, taken along cut line C-C as shown in FIG. 3g, in accordance with an example implementation of the present disclosure.

FIGS. 5a and 5b illustrate detailed cross-sectional views of the bracket cavity of the fastener, taken along cut line B-B as shown in FIG. 3g, in accordance with an example implementation of the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Such fasteners, generally, include a body portion to which the component is mounted and include a shank which fits into the opening in the other component. The shank includes cantilevered arms having a snap-fit lock at their respective distal end away from the body portion. The cantilevered arms may be biased to span farther than the size of the opening into which the shank is to be fitted. The cantilevered structure allows the arms to be yieldable such that the snap-fit lock may engage with a complementary part, for instance, around the opening which receives the fastener. Accordingly, when the mounted fastener is to be secured in the component, the shank is forced into the opening. As the shank enters and slides through the opening, the cantilevered arms move slightly inwardly to allow insertion of the fastener, until the snap-fit locks on the arms engage with the component.

Such fasteners are usually limited in terms of design by a degree of ease or difficulty with which the fastener may be deployed in and, accordingly, be withdrawn from the opening in the component. In other words, the design of the fasteners is such that if they are easily deployed, they may be easily, and sometimes inadvertently, withdrawn, or if they are to be made difficult to be withdrawn, they are difficult to deploy. Accordingly, the fasteners which are designed to be ergonomically viable may be found to be lacking in adequately holding the components together, whereas the fasteners which are capable of properly holding the components together may not be

### Ergonomic in Use.

Fastener systems, including two components that are secured together a fastener are described. One of the components may be mounted on the fastener and another component may have an opening to receive the fastener having the component mounted thereon. The component mounted to the fastener is referred to as a child component, whereas the component in which the opening is provided for receiving the fastener is referred to as a mother component. The mother component may be interchangeably referred to as the first component. The child component may be interchangeably referred to as a second component. In an example, the components may be parts of an instrument panel of a vehicle. For instance, the mother component may be a dashboard, and the child component may be a heating-ventilation-air-conditioning (HVAC) vent to be mounted to the dashboard. According to one aspect, the approaches involve designing the fastener in such a manner that the fastener is ergonomic in terms of being inserted into the opening in the mother component, whereas at the time of separation or withdrawal from the opening, the fastener may involve a considerably large amount of force in comparison to that for insertion. In other words, the fastener is designed to have a low insertion force but to have a high separation force.

In one aspect, the fastener may include a body portion having a plurality of ribs. The plurality of ribs may be running substantially parallel to each other and arranged to form a bend section. The fastener may include a bridge, and the plurality of the ribs may be interconnected by the bridge at the bend section. The interconnection of the ribs at the bridge may allow the ribs to flex about the bridge during insertion into the opening of the mother component while maintaining structural integrity of the fastener, as will be explained in detail later. The fastener may further include a shank portion extending from the body portion. The shank portion may include a plurality of arms, each of the plurality of arms may be connected to a respective rib at a point of connection located at a free end of each of the ribs. Each of the plurality of the arms may be cantilevered at the respective point of connection and may be hingeable relative to the point of connection of the rib. The free ends of the plurality of arms may form one end of the fastener referred to as a first end. An end of the fastener at a bend section of the plurality of ribs may form another end of the fastener, referred to as a second end, and is opposite the first end.

At the first end of the fastener, the ends of the plurality of arms on either side of the bend section may be connected to each other by an integrating element. The fastener may, therefore, have two integrating elements at the first end, on either side of the bend section, connecting the ends of the respective arms on the respective side of the bend section. In addition, the fastener may have a plurality of mounting brackets at which the child component may be mounted to the fastener. In an example, at least one mounting bracket may be provided at the first end on either side of the bend section, supported by or coupled to the integrating element. Each mounting bracket may have a seat, the seats of the two mounting brackets on either side of the bend section forming a bucket-shaped opening for receiving the child component to be mounted onto the fastener. In an example, the child component may include a clip tower formed as a protrusion. The clip tower may be integral with the second component or couplable to the second component. The clip tower may cooperate with the bucket-shaped opening of the mounting brackets to mount the child component at the fastener. The fastener having the child component mounted thereon may then be inserted into the opening in the mother component, thereby fixing the two components together.

In an example, the mounting bracket may be configured to reduce the insertion or mounting force required to mount the child component, together with the clip tower, onto the fastener. Each of the mounting brackets may include a bracket cavity. The bracket cavity may extend at least partly inwardly from the outer surface of the bracket. In an example, the bracket cavity may include a cavity floor surface, a pair of cavity sidewall surfaces, and a rear wall surface. The pair of cavity sidewall surfaces may extend between the outer surface of the mounting bracket and opposing sides of the cavity floor along a length direction of the mounting bracket. The rear wall surface may extend between the outer surface of the mounting bracket and the cavity floor in a width direction. In some embodiments, the angle between the rear wall surface and the cavity floor surface may fall within a specified range of 90 to 120 degrees. The mounting bracket including the bracket cavity may be designed to provide controlled flexibility within the bracket region. The controlled flexibility may allow the mounting bracket to flex more easily during mounting of the child component together with the clip tower on the fastener, while still maintaining the structural integrity required for secure engagement. The bracket cavity may also be designed to reduce material usage and overall weight of the fastener without compromising strength. By optimizing the size, shape, and depth of the bracket cavity, the mounting bracket may improve ease of insertion of the fastener into the child component through clip tower.

At the second end of the fastener, i.e., at the bend section, the plurality of ribs may be joined by the bridge. According to an aspect, the size of the bridge may be selected based on an insertion force to be applied for inserting the fastener into the opening in the mother component. In other words, the size of the bridge may be determined based on the insertion force for which the fastener is designed. For example, a width or a height or both of the bridge may be selected for determining an insertion force for the fastener. The width of the bridge may be the dimension of the bridge extending on either side of the bend section and the height of the bridge may be the dimension of the bridge extending in a direction along the first and second ends of the fastener.

Accordingly, as an example, as the size of the bridge is small, the flexibility of the ribs at the bend section may be high, thereby requiring a low insertion force to be applied for inserting the fastener into the mother component. In addition, the size of the bridge may be further determined such that the fastener does not undergo failure or breakage while inserting and withdrawing the fastener from the mother component. Therefore, the size of the bridge of the fastener may be determined based on a trade-off between the insertion force and the failure of the fastener. In one example, the size of the bridge may be decided based on a material of the fastener, duly considering the above discussed factors in addition.

According to an additional aspect, at least one of the plurality of the ribs may be designed to have a recessed portion to regulate at least an insertion force of the fastener into the opening of the mother component. The recessed portion may be formed along at least a portion of the rib between the point of connection and the bend section. Therefore, in addition to the size of the bridge, the recessed portion on the ribs may further determine the insertion force to be applied for inserting the fastener into the opening in the mother component.

In an example, the recessed portion may be positioned on an edge of the rib formed between a first side surface and an outer planar surface of the rib. The recessed portion may include a floor surface and a sidewall surface extending between the outer planar surface of the rib and the floor surface. In an example, a first thickness may be measured between the first side surface of the rib and a second side surface of the rib, the second side surface being opposite the first side surface. Similarly, a second thickness may be measured between the second side surface of the rib and an edge of a sidewall that transitions from the outer planar surface of the rib. The first thickness may be greater than the second thickness. In the present subject matter, since the recessed portion reduces the second thickness relative to the first thickness, the rib presents at least a portion having a smaller cross-sectional dimension, particularly around the portion that first enters toward the opening of the mother component during insertion. The reduced cross-sectional dimension decreases the likelihood of premature interference between the ribs of the fastener and the walls of the opening, permitting smoother advancement of the fastener into the mother component and yielding a lower insertion force relative to a rib of uniform thickness.

In addition, the fastener may also have features that may determine the separation force for the fastener, i.e., the force to be applied on the fastener for withdrawing the fastener from the mother component. According to an aspect, the point of connection between the rib and the arm for each of the plurality of ribs may be designed based on the separation force of the fastener. In other words, the separation force may be subject to the design of the ribs and the arms of the fastener. The size of the point of connection between the ribs and the arms may be selected for determining the separation force for the fastener. In some examples, the point of connection may include a profile extending laterally outward to form a locking feature. In certain configurations, the profile may form an angle greater than 90 degrees with the arm. The features ensure that while the arms may flex easily during insertion, the profile may resist withdrawal forces and maintain a strong mechanical lock once engaged.

As mentioned previously, the arm may be hingeable about a point of connection to the rib that it is connected to. For instance, a width or cross-sectional thickness or both of the point of connection, when high, may reduce a flexibility, and therefore, the hingeability, of the arms with respect to the ribs, thereby requiring a high separation force for removing the fastener from the component. However, as mentioned previously, the size of the points of connection may be determined based on a trade-off between the separation force and the failure of the fastener. In one example, the size of the points of connection may be decided based on a material of the fastener, duly considering the above discussed factors in addition.

Accordingly, the fastener may be designed in a way that the insertion force and the separation force for the fastener may be independently controlled. As an example, and not as a limitation, the fastener may have a nominal insertion force less than 45 Newtons (N) but may be designed to have a separation force of at least 130 N in another case, depending on the design of the fastener. In other words, the design of the fastener is such that the insertion force of the fastener has no bearing on the separation force of the fastener and vice versa. As will be understood, the above values of insertion and separation forces are provided as examples and are not to be construed to be limiting. In addition to the functional benefits, the recessed portion and the bracket cavity may simplify the manufacturing process of the fastener. For instance, when the fastener is formed via a plastic injection molding process, the geometry of the recessed portion and the bracket cavity may reduce the number of sliders or side actions required in the injection mold tooling. The reduced tooling complexity may lower manufacturing costs and improve production efficiency.

The above and other features, aspects, and advantages of the subject matter will be better explained with regard to the following description, and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

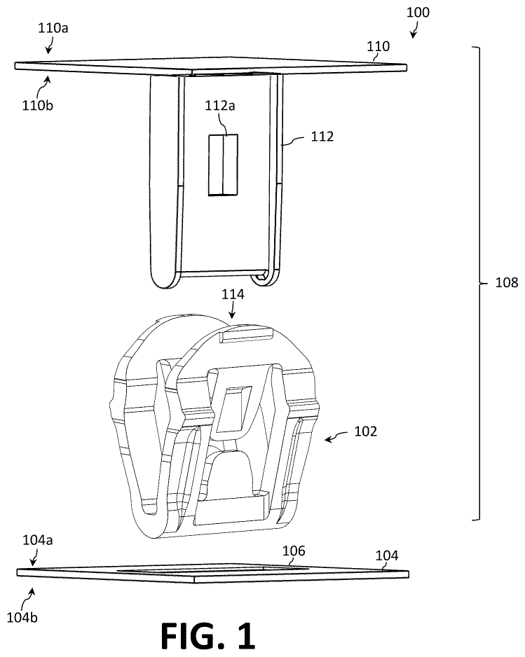

FIG. 1 illustrates an isometric assembly view of a fastener system 100, in accordance with an example implementation of the present disclosure. As illustrated, the fastener system 100 may generally include a fastener 102 configured to join a first component 104 and a second component 110 via a clip tower 112 associated with the second component 110. The first component 104 and the second component 110 may be, for example, automotive panels. The first component 104 may be interchangeably referred to as a mother component 104. The second component 110 may be interchangeably referred to as a child component 110.

Depending on the application, the first component 104, the second component 110, and/or the clip tower 112 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example panels include, without limitation, door trim panels, moldings, trim pieces, hoods, doors, pillars (e.g., an A-pillar, B-pillar, C-pillar, etc.), dashboard components (e.g., a cross member, bracket, frame, etc.), seat frames, center consoles, fenders, sheet metal framework, and/or other substrates (whether used as interior or exterior surfaces).

The first component 104 may include one or more openings 106, while the second component 110 includes one or more clip towers 112 having, for example, a seating portion 112a. The openings 106 may interchangeably be referred to as holes. Each opening 106 may be configured to receive or engage the fastener 102 and the corresponding clip tower 112. The fastener 102 and its corresponding clip tower 112 may be provided as a part-in-assembly (PIA) component 108. The clip towers 112 may be configured to engage the fasteners 102 via, for example, features of the fasteners 102 and the seating portion 112a. The first component 104 may define an A-surface 104a and a B-surface 104b (undersurface), and similarly, the second component 110 may define an A-surface 110a and a B-surface 110b (undersurface). The A-surface 104a of the first component 104 may be the outward-facing surface, while the B-surface 104b may be the inward-facing surface. Upon assembly, the A-surface 104a of the first component 104 may face the B-surface 110b of the second component 110.

The A-surface 110a, also known as a class A surface, may remain visible post-assembly and may be aesthetically enhanced (e.g., textured, coated, or decorated) and typically free from attachment devices or related features. In contrast, the B-surface 110b, or class B surface, may be concealed after assembly and usually incorporates various attachment devices or related features. For example, in a vehicle's instrument panel, the second component 110 may be a dashboard, and the first component 104 may be an instrument cluster mounted onto the dashboard, or vice versa.

The second component 110 may incorporate attachment devices or features, such as the clip towers 112, which protrude from the B-surface 110b. Each clip tower 112 may be generally perpendicular to the second component 110 and may include a seating portion 112a, such as a slot or window, which is configured to receive or otherwise engage a portion of the fastener 102. The clip towers 112 may be integral with the second component 110 (e.g., co-molded) or attached separately (e.g., using adhesive).

The fastener 102 may be secured onto the clip tower 112 of the second component 110, forming a PIA component 108. For example, the fastener 102 may define a clip channel 114 that is configured to receive at least a portion of the clip towers 112 (e.g., starting at a leading end of the clip towers 112). The PIA component 108 may then be attached to the first component 104 by an end-user. In some scenarios, the PIA component 108 may be pre-assembled at the factory and shipped to the end-user for final assembly with the first component 104.

In some examples, the fastener 102 may be configured to be ergonomic during insertion into the opening 106 of the first component 104, requiring a relatively low insertion force. However, during separation or withdrawal from the opening 106, the fastener 102 may necessitate a considerably higher force compared to insertion. In other words, the fastener 102 may be configured to have a low insertion force but a relatively high separation force. Notably, the insertion and separation forces are independent of each other.

The fastener 102 may be constructed from a generally rigid material, such as plastic. The fastener 102 may be fabricated from synthetic or semi-synthetic polymers. For instance, the plastic material may include polypropylene (PP), acrylonitrile butadiene styrene (ABS), polycarbonate (PC), polymethylmethacrylate (PMMA), polyoxymethylene (POM), or a combination thereof. Notably, the fastener 102 may be fabricated from plastic while remaining suitable for use with metal components. Therefore, in one example, the fastener 102 may be made from plastic, while the first component 104 and/or the second component 110 are metal, plastic, composite, etc.

The fastener 102 may be formed via a plastic injection molding process. In other examples, the fastener 102 may be a printed thermoplastic component formed via an additive manufacturing technique, advantageous for creating complex or detailed features. Additive manufacturing techniques eliminate the need for mold tooling associated with plastic injection molding, reducing initial manufacturing costs, especially beneficial for low-volume productions. Example additive manufacturing processes include material extrusion (e.g., fused deposition modeling (FDM)), stereolithography (SLA), selective laser sintering (SLS), material jetting, binder jetting, powder bed fusion, directed energy deposition, or VAT photopolymerization.

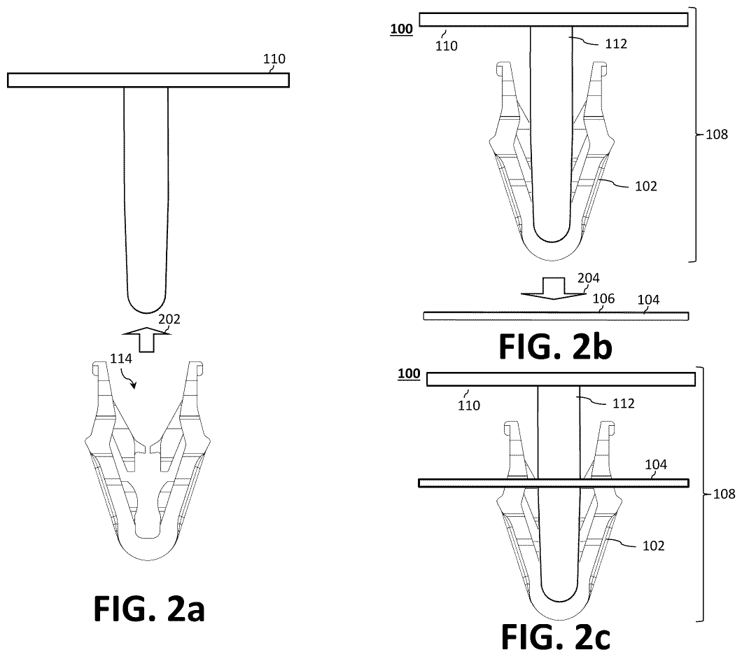

FIGS. 2a-2c illustrate side views of the fastener system in different stages of assembly, in accordance with an example implementation of the present disclosure. The fastener 102 may be slipped onto the second component 110 as indicated by arrow 202 to define the PIA component 108. In particular, the second component 110 may include the clip tower 112 and the fastener 102 may be slipped onto the clip tower 112 or vice versa to form the PIA component 108. The clip tower 112 may be received at the clip channel 114 of the fastener 102. FIG. 2b illustrates the assembled PIA component 108 being at least partially inserted in the opening 106 of the first component 104 as indicated by arrow 204. FIG. 2c illustrates the PIA component 108 fully assembled with the first component 104.

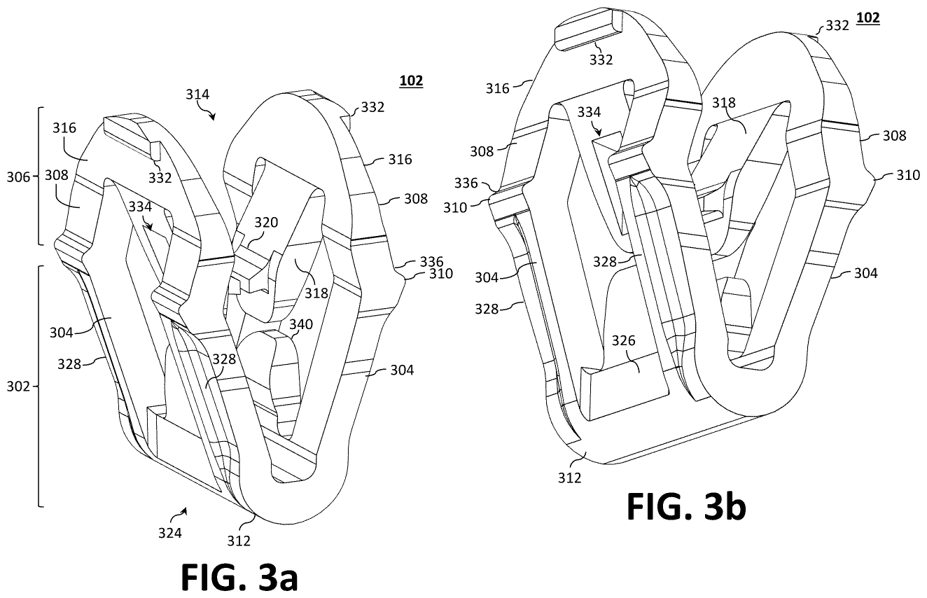

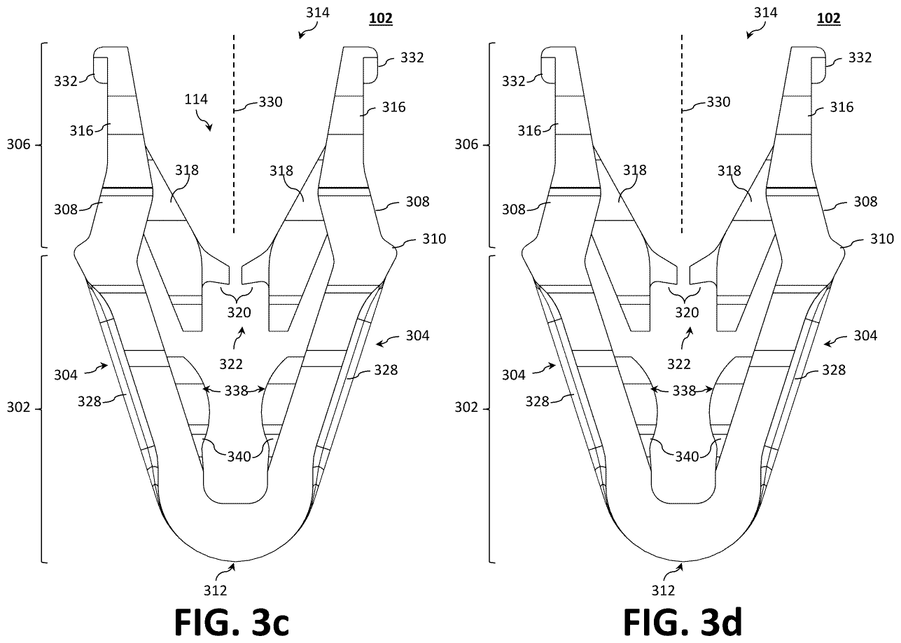

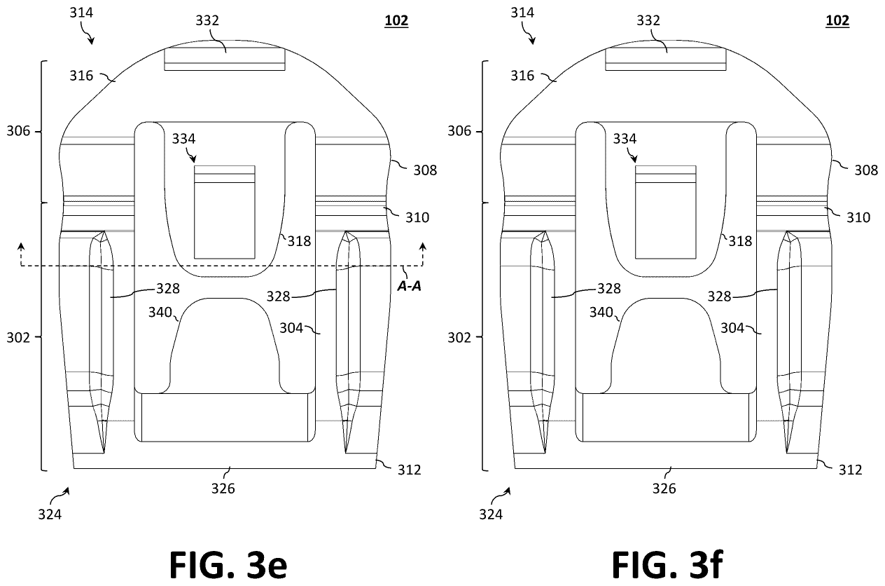

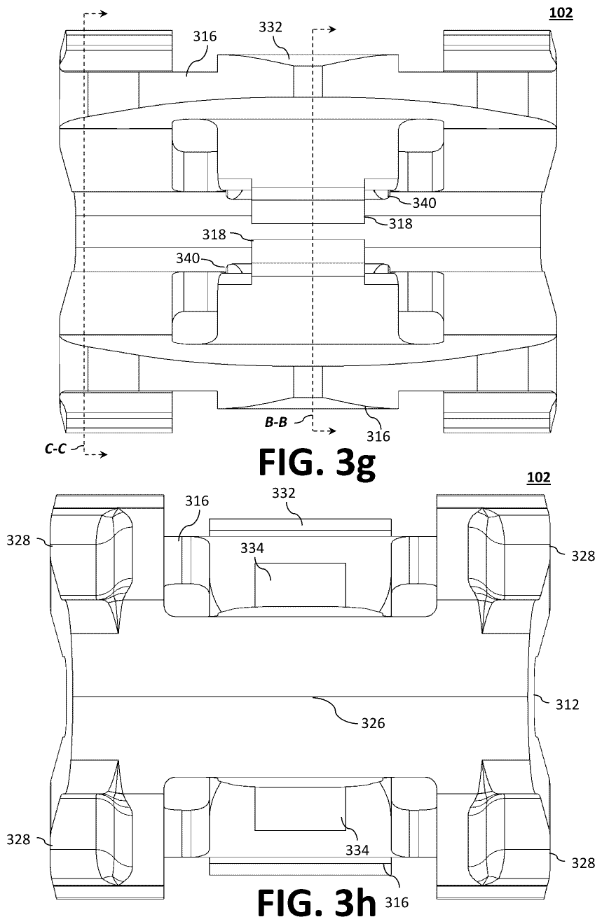

FIGS. 3a and 3b illustrate, respectively, top side and under side isometric views of the fastener 102, in accordance with an example implementation of the present disclosure. FIGS. 3c and 3d illustrate front and rear elevation views of the fastener 102, in accordance with an example implementation of the present disclosure. FIGS. 3e and 3f illustrate first and second side elevation views of the fastener 102, in accordance with an example implementation of the present disclosure. For sake of brevity, FIGS. 3a-3f will be explained in conjunction with each other. According to an aspect of the present subject matter, the fastener may be designed in such a manner that the fastener may be ergonomic in terms of being inserted into the opening in the mother component, whereas at the time of separation or withdrawal from the opening, the fastener may require a considerably large amount of force in comparison to that for insertion. In other words, the fastener may be designed to have a low insertion force while having a relatively high separation force. At the same time, the insertion force and the separation force for which the fastener may be designed may have no bearing on each other.

The fastener 102 can include a body portion 302 formed by a plurality of ribs 304 running parallel to each other and forming a bend section 312. The fastener 102 may further include a shank portion 306 extending from the body portion 302. The shank portion 306 may include a plurality of arms 308, with each arm 308 coupled to a free end of the rib 304 and extending therefrom in a direction away from the body portion 302. Each arm 308 may be cantilevered at the free end of the rib 304 to which that arm 308 is attached. Accordingly, the arm 308 may be hingeable about a point of connection 310 to the rib 304. In other words, the arm 308 may be hingeable about a junction between the arm 308 and the rib 304.

The free ends of the plurality of arms 308 can form a first end 314 of the fastener 102, whereas an end of the fastener 102 at the bend section 312 of the plurality of ribs 304 can form a second end 324 of the fastener 102 opposite the first end 314. The second end 324 of the fastener 102 can be formed as being tapered for inserting the fastener 102 into the opening 106 in the mother component 104 to which the fastener 102 is to be fitted.

At the first end of the fastener 102, the ends of the plurality of arms 308 on one side of the bend section 312 can be connected to each other as well as ends of the plurality of arms 308 on the other side of the bend section 312 can be connected to each other. In other words, on either side of the bend section 312, the ends of the arms 308 can be connected to each other by an integrating element 316. The fastener 102, therefore, may include two integrating elements 316 at the first end 314 of the fastener 102, on either side of the bend section 312.

In addition, to mount the child component 110 to the fastener 102, the fastener 102 may have a plurality of mounting brackets 318. In an example, at least one mounting bracket 318 can be provided on either side of the bend section 312. The mounting brackets 318 may be supported at the integrating element 316 at the first end 314. In said example, to accommodate the child component 110, each mounting bracket 318 may have a seat 320. Further, the seats 320 of the two mounting brackets 318 on either side of the bend section 312 may form a bucket shaped opening 322 for receiving the child component 110 to be mounted onto the fastener 102. For instance, the child component 110 may include a clip tower 112 formed as a protrusion which can cooperate with the bucket shaped opening 322 of the mounting brackets 318 to mount the child component 110 at the fastener 102. In an example, the clip tower 112 may have a seating portion 112a, for instance formed as a slot to sit in the bucket shaped opening 322 of the fastener 102. The fastener 102 having the child component 110 mounted thereon, i.e., the PIA component 108, may then be inserted into the opening 106 in the mother component 104, thereby fixing the two components together.

In an example, the mounting bracket 318 may include a tapered or chamfered entry portion configured to facilitate insertion of the clip tower 112 into the fastener 102. The tapered entry portion may be provided on the surface of the mounting bracket 318 that faces the clip tower 112 during assembly. The taper may guide the clip tower 112 towards the seats 320 of the mounting brackets 318, reducing the insertion force required to mount the child component 110 onto the fastener 102. In some examples, the tapered entry portion may extend along at least a portion of the mounting bracket 318 adjacent to the bucket-shaped opening 322. The taper on the mounting bracket 318 may complement the taper on the mating face 338 of the grasping elements 340, collectively providing a self-centering effect that aligns the clip tower 112 with the fastener 102 during mounting. The tapered configuration of the mounting bracket 318 may reduce misalignment issues and streamline the assembly process.

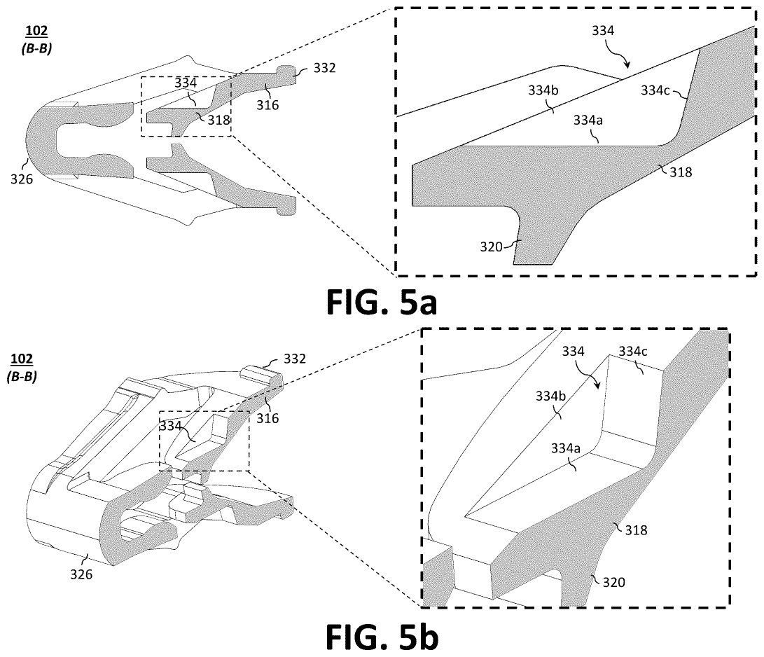

In an example, the mounting bracket 318 may be configured to reduce the insertion or mounting force required to mount the child component 110, together with the clip tower 112, onto the fastener 102. Each of the mounting bracket 318 may include a bracket cavity 334. The bracket cavity 334 may extend at least partly inwardly from an outer surface of the mounting bracket 318. The outer surface of the mounting bracket 318 may be the surface opposite the surface on which the seats 320 of the mounting bracket 318 are provided. The manner in which the mounting bracket 318 including the bracket cavity 334 may be designed to provide controlled flexibility of the mounting bracket 318, thereby allowing the mounting bracket 318 to flex more easily during mounting of the child component 110 together with the clip tower 112 on the fastener 102, will be explained in detail with reference to FIGS. 5a and 5b.

Each integrating element 316 may include an engagement feature 332 that may extend away from the axis 330. In other words, the illustrated integrating element 316 may include an engagement feature 332 at a distal end thereof that extends outwardly from the fastener 102. In operation, the engagement features 332 can be used by the user to grasp the fastener 102 (e.g., during installation or removal from a clip tower 112) or to engage one or more of the clip towers 112, the first component 104 and/or the second component 110.

Further, as mentioned previously, the fastener 102 may be inserted into the opening 106 of the mother component 104 in the direction of the second end 324 being inserted first. At the second end 324 of the fastener 102, i.e., at the bend section 312, the plurality of ribs 304 may be joined by a bridge 326. According to an aspect, the bridge 326 may be designed in a way that the bridge 326 may impart flexural ability to the ribs 304 for being inserted into the opening 106, since the opening 106 may be sized smaller than the span of the ribs 304 on either side of the bend section 312.

According to an aspect, a size of the bridge 326 can be selected based on an insertion force that the fastener 102 may be designed for. In other words, the size of the bridge 326 may be determined based on the insertion force to be applied for inserting the fastener 102 into the opening 106 in the mother component 104. A width or a height or both of the bridge 326 may determine an insertion force applicable for the fastener 102. In other words, starting from the insertion force, the insertion force may be a factor based on which the width or the height or both of the bridge 326 can be designed. The width of the bridge 326 can be the dimension of the bridge 326 extending on either side of the bend section 312. The height of the bridge 326 can be the dimension of the bridge 326 extending in a direction along the first end 314 and the second end 324 of the fastener 102.

Accordingly, as an example, the size of the bridge 326 may be selected to be small, so that the flexibility of the ribs 304 at the bend section 312 may be high, thereby requiring a low insertion force to be applied for inserting the fastener 102 into the mother component 104. In addition, the size of the bridge 326 may be further determined factoring in that the fastener 102 does not undergo failure or breakage while inserting and withdrawing the fastener 102 from the mother component 104, for example when insertion and withdrawing are performed for multiple cycles. Therefore, the size of the bridge 326 of the fastener 102 can be determined based on a trade off between the insertion force and the failure of the fastener 102. Accordingly, the material of the fastener 102 can be an additional factor in determining the size of the bridge 326, with due consideration of the above discussed factors.

Further, the fastener 102 can also have features that can be designed based on the insertion force for the fastener 102, i.e., the force to be applied on the fastener 102 for inserting the fastener 102 onto the mother component 104. According to an aspect, the ribs 304 may be designed to have a tapered shape along their length to enhance their flexural ability without compromising their strength. In other words, the ribs 304 may be sufficiently yieldable or flexible to bend and enter the opening 106 of the mother component 104 during insertion, and after entering, may substantially regain their original span without undergoing failure.

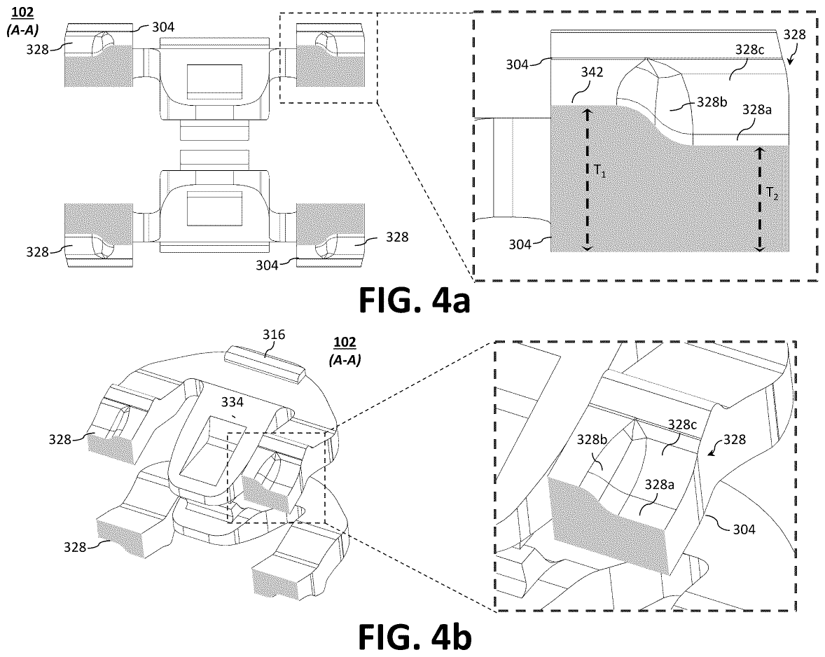

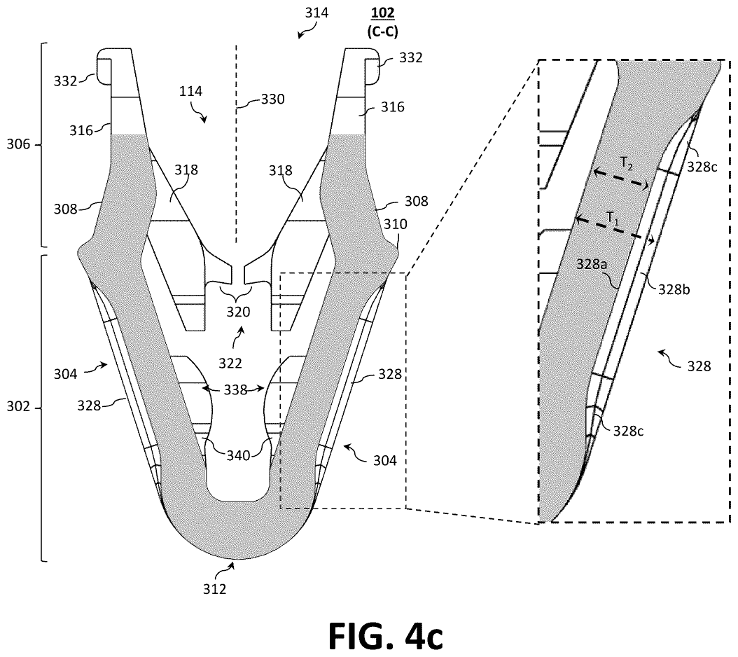

In another aspect, at least one of the ribs 304 may include a recessed portion 328 formed along a portion of the rib 304 between the point of connection 310 and the bend section 312. The recessed portion 328 may be interchangeably referred to as rib slot 328. The recessed portion 328 may present at least a portion of the rib 304 having a smaller cross-sectional dimension, particularly the portion of the rib 304 near to the second end 324 that first approaches the opening 106 of the mother component 104 during insertion of the fastener 102. The reduced cross section of the rib 304 may decrease the likelihood of premature interference between the ribs 304 of the fastener 102 and edges of the opening 106, permitting smoother advancement of the fastener 102 into the mother component 104 and yielding a lower insertion force relative to a rib 304 of uniform thickness. The manner in which the recessed portion 328 of the rib 304 may contribute to regulating the insertion force will be explained in detail with reference to FIGS. 4a-4d.

In addition, to maintain the fastener 102 in the opening 106, the arms 308 may be hingeable about the point of connection 310 to the respective rib 304 to which they are connected. Similar to the bridge 326, the point of connection 310 between each rib 304 and corresponding arm 308 may be designed to provide a flexural ability to the arms 308 with respect to the ribs 304 and to hold the fastener 102 within the opening 106. When the fastener 102 is inserted into the opening 106, it may sit with the arms 308 abutting the opening 106, and the arms 308 may exert a bias force on the edges of the opening 106 to securely retain the fastener 102 within the opening 106. The point of connection 310 may further include a profile extending in a laterally outward direction with respect to an axis 330 passing through the fastener 102 cutting through the bend section 312 across the ribs 304. The profile may form a sharp angle, for instance close to 90 degrees, with the arm 308, providing an acute curvature that supplements the arms 308 in preventing withdrawal of the fastener 102 from the opening 106 unless a considerable force is applied. In another example, the profile may be designed as a curved retention feature between the rib 304 and the arm 308 to enhance the locking ability of the fastener 102 within the opening 106. Additionally, the separation force required for withdrawing the fastener 102 from the mother component 104 may be regulated by the size of the point of connection 310 between the ribs 304 and the arms 308. For instance, a width or cross-sectional thickness, or both, of the point of connection 310, when large, may reduce the flexibility and hingeability of the arms 308 with respect to the ribs 304, thereby increasing the separation force. The size of the point of connection 310 may be determined based on a trade off between the targeted separation force and the mechanical durability of the fastener 102, and may also be selected in consideration of the material of the fastener 102.

Furthermore, the fastener 102 may include at least one grasping element 340 on either side of the bend section 312. The grasping elements 340 may be coupled to the bridge 326 and extend from the bridge 326 towards the first end 314 of the fastener 102. In other words, the grasping elements 340 may extend along the body portion 302, i.e., in the direction in which the body portion 302 of the fastener 102 extends. The grasping elements 340, as the name suggests, may function for gripping the child component 110 that is mounted onto the fastener 102. According to an aspect, the grasping elements 340 may have a mating face 338 which may directly come in contact with a surface of the child component 110 for gripping the child component 110. The mating face 338 can be shaped to taper in the direction from the first end 314 to the second end 324. In other words, the mating face 338 may be shaped to taper in the direction from the bend section 312 along the body portion 302, i.e., along the direction that the body portion 302 of the fastener 102 extends. The taper on the mating face 338 may enable it to align the child component 110, for instance, the clip tower 112 of the child component 110, towards the center of the bend section 312 when the child component 110 is being mounted to the fastener 102. The grasping elements 340 may ensure an effective mounting of the child component 110 to the fastener 102.

FIGS. 4a and 4b illustrate detailed cross-sectional views of the recessed portion 328 of the rib 304 of the fastener 102, taken along cut line A-A as shown in FIG. 3e, in accordance with an example implementation of the present disclosure. FIG. 4c illustrates a detailed cross-sectional view of the recessed portion 328 of the rib 304 of the fastener 102, taken along cut line C-C as shown in FIG. 3g, in accordance with an example implementation of the present disclosure. For sake of brevity, FIGS. 4a-4c will be explained in conjunction with each other.

Further, the fastener 102 can also have features that can be designed based on the insertion force for the fastener 102, i.e., the force to be applied on the fastener 102 for inserting the fastener 102 onto the mother component 104. In an aspect, at least one of the ribs 304 may include a recessed portion 328 formed along a portion of the rib 304 between the point of connection 310 and the bend section 312.

As best illustrated in FIG. 4a, each recessed portion 328 of the rib 304 may be positioned between a first side surface of the rib 304 and an outer planar surface of the rib 304. In an example, the recessed portion 328 may be formed such that the recess extends over at least a portion of the first side surface of the rib 304 and the outer planar surface of the rib 304. The first side surface of the rib 304 may be an outer side surface of the rib 304, positioned opposite an inner side surface of the rib 304. The inner side surface of the rib 304 may be the surface to which the bridge 326 may be connected at the bend section 312. The outer planar surface of the rib 304 may be the surface extending between the first side surface of the rib 304 and a second side surface of the rib 304, and may be the planar surface that is normally visible from the outside.

In an example, the recessed portion 328 may include a floor surface 328a and a sidewall surface 328b. The floor surface 328a may be positioned at a reduced height from the outer planar surface of the rib 304, thereby providing the structure for the recess. The sidewall surface 328b may extend in a length direction of the rib 304 between the outer planar surface of the rib 304 and the floor surface 328a. The recessed portion 328 may further include a pair of sloped surfaces 328c provided at opposite ends of the floor surface 328a and extending in a width direction of the rib 304. The sloped surfaces 328c may join the floor surface 328a and the outer planar surface of the rib 304 in the width direction.

A first thickness T1 may be measured between the first side surface of the rib 304 and the second side surface of the rib 304. Similarly, a second thickness T2 may be measured between the second side surface of the rib 304 and an edge of the sidewall surface 328b that transitions from the outer planar surface of the rib 304. In view of the recessed portion 328 of the ribs 304, the first thickness T1 may be greater than the second thickness T2. In an example, the second thickness T2 may be about 70 to 80 percent the thickness of the first thickness of T1. In the present subject matter, since the recessed portion 328 reduces the second thickness T2 of the rib 304 relative to the first thickness T1, the rib 304 presents at least a portion having a smaller cross sectional dimension, particularly the portion of the rib 304 adjacent to the second end 324 that first enters toward the opening 106 of the mother component 104 during insertion. The reduced dimension decreases the likelihood of premature interference between the ribs 304 of the fastener 102 and the edges of the opening 106 of the mother component 104, permitting smoother advancement of the fastener 102 into the mother component 104 with negligible insertion force until the point of connection 310 enters into the opening 106 of the mother component 104. In other words, when the fastener 102 having ribs 304 with the recessed portion 328 is inserted, the recessed portion 328 enables most of the rib 304 to traverse through the opening 106 without interacting with the edges of the opening 106 of the mother component 104. Therefore, no significant insertion force is required until the ribs 304 or the point of connection 310 interact with the edges of the opening 106. Therefore, the ribs 304 having the recessed portion 328 may considerably require a lower insertion force relative to ribs 304 of uniform thickness. The recessed portion 328 also optimizes material usage and reduces the overall weight of the fastener 102.

In an alternative or additionally, a third thickness may be measured between the outer planar surface of the rib 304 and an inner planar surface of the rib 304 in a region adjacent to the second side surface of the rib 304. Similarly, a fourth thickness may be measured between the outer planar surface of the rib 304 and an inner planar surface of the rib 304 in a region adjacent to the first side surface of the rib 304. The inner planar surface may be positioned opposite the outer planar surface and may extend between the first side surface and the second side surface of the rib 304. In view of the recessed portion 328 of the ribs 304, the third thickness may be greater than the fourth thickness.

In some examples, the recessed portion 328 may be dimensioned to receive a portion of the mother component 104. For instance, a ridge or protrusion may be integrally formed on the mother component 104 may slide along the recessed portion 328 to improve alignment of the fastener 102 with the opening 106 during assembly, thereby reducing misalignment issues and streamlining the assembly process. In the illustrated example, the sidewall surface 328b and the floor surface 328a are shaped to define concave fillets at an interface therebetween. The concave fillet may interact with and lock onto the ridge or protrusion integrally formed on the mother component 104 may slide along the recessed portion 328.

FIGS. 5a and 5b illustrate detailed cross-sectional views of the bracket cavity 334 of the fastener 102, taken along cut line B-B in FIG. 3g, in accordance with an example implementation of the present disclosure. As explained earlier, the mounting bracket 318 may be configured to reduce the insertion or mounting force required to mount the child component 110, together with the clip tower 112, onto the fastener 102. Each of the mounting bracket 318 may include a bracket cavity 334. The bracket cavity 334 may extend at least partly inwardly from an outer surface of the mounting bracket 318. The outer surface of the mounting bracket 318 may be the surface opposite the surface on which the seats 320 of the mounting bracket 318 are provided.

In an example, the bracket cavity 334 may include a cavity floor surface 334a, a pair of cavity sidewall surfaces 334b, and a rear wall surface 334c. The cavity sidewall surfaces 334b may extend between the outer surface of the mounting bracket 318 and opposing sides of the cavity floor surface 334a along a length direction of the mounting bracket 318. The rear wall surface 334c may extend between the outer surface of the mounting bracket 318 and the cavity floor surface 334a in a width direction of the mounting bracket 318.

In the illustrated examples, the opposed cavity sidewall surfaces 334b and the cavity floor surface 334a are substantially perpendicular to one another. Similarly, the rear wall surface 334c and the cavity floor surface 334a are oriented transversely to each other but are not necessarily perpendicular. For example, as illustrated in FIG. 5a, the rear wall surface 334c and the cavity floor surface 334 a define an obtuse angle in the range of approximately 90 to 120 degrees, which may serve to avoid snag points during assembly. In the illustrated example, as best show in FIG. 5a, the cavity floor surface 334a is parallel to the axis 330. Further, the cavity floor surface 334a and the rear wall surface 334c are configured to define a concave fillet at an interface therebetween.

The mounting bracket 318 including the bracket cavity 334 may be designed to provide controlled flexibility of the mounting bracket 318. The controlled flexibility may allow the mounting bracket 318 to flex more easily during mounting of the child component 110 together with the clip tower 112 on the fastener 102, while still maintaining the structural integrity required for secure engagement. The bracket cavity 334 may also be designed to reduce material usage and overall weight of the fastener 102 without compromising strength. By optimizing the size, shape, and depth of the bracket cavity 334, the mounting bracket 318 may improve ease of insertion of the fastener 102 into the child component 110 through clip tower 112.

In addition, the size, shape, and depth of the bracket cavity 334 may be determined such that the fastener 102 does not undergo failure or breakage while inserting and withdrawing the fastener 102 from the clip tower 112 of the child component 110. Therefore, the size, shape, and depth of the bracket cavity 334 of the fastener 102 may be determined based on a trade-off between the insertion force and the failure of the fastener 102. In one example, the size of bracket cavity 334 may be decided based on a material of the fastener 102, duly considering the above discussed factors in addition. The bracket cavity 334 may include reinforcing features, such as ribs 304 or contour variations.

In some examples, the bracket cavity 334 is dimensioned to receive a portion of the mother component 104 and/or the child component 110. For instance, a ridge or protrusion may be integrally formed on one or both of the mother component 104 and the child component 110 may slide into the bracket cavity 334 to improve alignment of the fastener 102 with the opening 106 during assembly, thereby reducing misalignment issues and streamlining the assembly process.

In operation, the child component 110 together with the clip tower 112 may be inserted into the fastener 102 to form the PIA component 108. During insertion of the clip tower 112 into the fastener 102, the tapered entry portion of the mounting brackets 318 may guide the clip tower 112 towards the seats 320, facilitating alignment and reducing the mounting force. The bracket cavity 334 may allow the mounting brackets 318 to flex in a controlled manner during engagement with the clip tower 112, further enhancing ease of insertion while maintaining structural integrity for secure retention. Additionally, the grasping elements 340 with the tapered mating face 338 may engage the clip tower 112 and align the clip tower 112 towards the center of the bend section 312, ensuring effective mounting of the child component 110 to the fastener 102.

Once the PIA component 108 is formed, the PIA component 108 may be inserted into the opening 106 of the mother component 104 with the second end 324 entering first. During insertion, the recessed portion 328 on the ribs 304 may delay the interaction between the ribs 304 and the edges of the opening 106. In other words, the reduced cross-sectional dimension of the ribs 304 at the recessed portion 328 may enable most of the rib 304 to traverse through the opening 106 without interfering with the edges of the opening 106. Accordingly, no significant insertion force may be required until the point of connection 310 between the ribs 304 and the arms 308 approaches the edges of the opening 106. The flexibility imparted by the bridge 326 at the bend section 312 may further allow the ribs 304 to flex inwardly during insertion, contributing to a low overall insertion force.

Once the fastener 102 is fully inserted into the opening 106, the arms 308 may abut the edges of the opening 106 and exert a bias force to retain the fastener 102 within the opening 106. The point of connection 310, having a profile extending laterally outward to form a locking feature, may resist withdrawal forces and maintain a strong mechanical lock with the mother component 104. The size of the point of connection 310 may be configured to provide high separation force, thereby preventing inadvertent withdrawal of the fastener 102 from the opening 106.

Accordingly, the fastener 102 may be configured to have a low insertion force, for example less than 45 Newtons, while having a high separation force, for example at least 130 Newtons, thereby providing an ergonomic assembly experience without compromising retention strength. In addition to the functional benefits, the recessed portion 328 and the bracket cavity 334 may reduce material usage and overall weight of the fastener 102. Furthermore, the geometry of the recessed portion 328 and the bracket cavity 334 may simplify the manufacturing process, for instance by reducing the number of sliders required in injection mold tooling.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastener comprising:
a body portion, the body portion comprising a plurality of ribs arranged to form a bend section;
a bridge connecting the plurality of ribs to one other at the bend section; and
a shank portion extending from the body portion, the shank portion comprising a plurality of arms, wherein each of the plurality of arms is connected to a respective rib of the plurality of ribs at a point of connection located at a free end of each of the plurality of the ribs, each of the plurality of arms being cantilevered at the point of connection and extending therefrom in a direction away from the body portion, wherein each of the plurality of arms is hingeable about the point of connection with the rib;
wherein at least one of the plurality of ribs comprises a recessed portion formed along at least a portion of the rib between the point of connection and the bend section, the recessed portion configured to regulate at least an insertion force of the fastener.

2. The fastener of claim 1, wherein the recessed portion is positioned between a first side surface and an outer planar surface of one of the ribs, the recessed portion comprises:
a floor surface; and
a sidewall surface extending between the outer planar surface of the rib and the floor surface.

3. The fastener of claim 2, wherein the at least one of the plurality of ribs has:
a first thickness measured between the first side surface of the rib and a second side surface of the rib, the second side surface being opposite the first side surface, and
a second thickness measured between the second side surface of the rib and an edge of a sidewall that transitions from the outer planar surface of the rib,
wherein the first thickness is greater than the second thickness.

4. The fastener of claim 1, wherein at least one of a width and a cross-sectional thickness of the point of connections between each of the arms and the ribs are designed to regulate a separation force of the fastener.

5. The fastener of claim 4, wherein the point of connection between the arm and the rib has a profile extending in a laterally outward direction to form a locking feature of the fastener.

6. The fastener of claim 5, wherein the profile forms an angle greater than 90 degrees with the arm.

7. The fastener of claim 1, wherein the shank portion further includes an integrating element connecting free ends of the plurality of arms on either side of the bend section to each other.

8. The fastener of claim 7, comprising a plurality of mounting brackets, at least one of the plurality of the mounting brackets being provided on either side of the bend section and supported by the integrating element.

9. The fastener of claim 8, wherein each of the mounting brackets comprises a bracket cavity formed on an outer surface of the mounting bracket and extending inwardly therefrom.

10. The fastener of claim 9, wherein at least one bracket cavity comprises:
a cavity floor surface,
a pair of cavity sidewalls extending between the outer surface of the at least mounting bracket and opposing sides of the cavity floor surface along a length direction of the mounting bracket, and
a rear wall surface extending between the outer surface of the mounting bracket and the cavity floor surface in a width direction of the at least one mounting bracket.

11. The fastener of claim 10, wherein an angle between the rear wall surface and the cavity floor surface is in a range of 90 to 120 degrees.

12. The fastener of claim 1, wherein at least one of a width and a height of the bridge is designed to regulate the insertion force of the fastener.

13. The fastener of claim 1, comprising at least one grasping element on either side of the bend section, the at least one grasping element being coupled to the bridge and extending from the bridge along the body portion of the fastener.

14. The fastener of claim 1, wherein the fastener is designed for a separation force of at least 130 Newtons and for the insertion force of less than 45 Newtons.

15. A fastener system comprising:
a first component having an opening;
a second component having a clip tower extending therefrom; and
a fastener configured to couple the first component and the second component, the fastener being adapted to engage the clip tower associated with the second component and to be received within the opening of the first component, the fastener comprising:
a body portion, the body portion comprising a plurality of ribs arranged to form a bend section;
a bridge connecting the plurality of ribs to one other at the bend section; and
a shank portion extending from the body portion, the shank portion comprising a plurality of arms, wherein each of the plurality of arms is connected to a respective rib of the plurality of ribs at a point of connection located at a free end of each of the plurality of the ribs, each of the plurality of arms being cantilevered at the point of connection and extending therefrom in a direction away from the body portion, wherein each of the plurality of arms is hingeable about the point of connection with the rib;
wherein at least one of the plurality of ribs comprises a recessed portion formed along at least a portion of the rib between the point of connection and the bend section, the recessed portion configured to regulate at least an insertion force of the fastener.

16. The fastener system of claim 15, wherein the body portion is configured to engage with the clip tower between the plurality of ribs.

17. The fastener system of claim 15, wherein the clip tower is at least one of: integral with the second component and couplable with the second component.

18. The fastener system of claim 15,
wherein the fastener comprises at least one grasping element on either side of the bend section, the at least one grasping element being coupled to the bridge and extending from the bridge along the body portion of the fastener,
wherein the at least one grasping element comprises a mating face shaped to taper in the direction from the bend section along the body portion to align the clip tower towards a center of the bend section when the clip tower is being engaged with the fastener.

19. The fastener system of claim 15,
wherein the shank portion includes an integrating element connecting free ends of the plurality of arms on either side of the bend section to each other, and
wherein the integrating element comprises an engagement feature at a distal end thereof that extends outwardly from the fastener and away from an axis of the fastener, the engagement feature configured to be grasped by a user during installation or removal of the fastener from the clip tower.
